(19) United States
(12) Patent Application Publication
(10) Pub. No.: US 2023/0137704 A1
(43) Pub. Date: May 4, 2023

(54) PANEL LOCK

(71) Applicant: WENZHOU YEEKA LOCK TECHNOLOGY CO., LTD., WENZHOU (CN)

(72) Inventors: FABRICE VITRY, SHANGHAI (CN); HUASHAN CAI, HUANGSHI (CN); WENGUANG XIANG, WENZHOU (CN)

(21) Appl. No.: 17/943,201

(22) Filed: Sep. 13, 2022

(30) Foreign Application Priority Data
Oct. 28, 2021 (CN) 202111266141.4

(51) Int. Cl. E05B 65/00; E05B 57/00; E05B 7/00; E05B 13/00

(52) U.S. Cl. CPC E05B 65/006; E05B 57/00; E05B 7/00; E05B 13/002

(57) ABSTRACT

A panel lock includes a shell, a rotating shaft, a locking tab, a handle, a latch hook and a first elastic spring. The rotating shaft is rotatably mounted in the shell. The locking tab is connected to and rotates along with the rotary shaft to realize unlocking and locking. The handle is rotatably mounted to the rotating shaft, and has a first position being folded and a second position being lifted during rotation about a first axis perpendicular to the rotating shaft. The handle includes a latching groove and a guiding portion arranged at a side of the latching groove. The latch hook is rotatably mounted in the shell. The first elastic spring is arranged between the latch hook and the shell. Automatic locking of the handle can be realized during the movement of the handle from the second position to the first position.

### CROSS-REFERENCE TO RELATED APPLICATIONS

This application claims priority to Chinese Patent Application No. 202111266141.4, filed on Oct. 28, 2021, the entire contents of which are hereby incorporated by reference.

### TECHNICAL FIELD

The present application relates to the technical field of locks, and in particular to a panel lock.

### BACKGROUND

Panel locks are widely used in various industries, such as Marine ships and boats, Industrial Generators, HVAC, Construction Equipment, Transportation vehicles, trucks, caravans, etc. The panel lock generally includes a handle that is installed in a groove of a panel, or in a shell mounted onto the panel. The handle may be pulled out from the groove by hand to rotate to unlock or lock and has a folded state that is folded into the groove of the panel and flushes with the panel.

Such panel locks are described in the related art, such as in U.S. Pat. Nos. 5,526,660, 6,454,321B1, 4,706,478 and 7,748,246B1, in which the handle is in a free state and unlockable in the folded position; or, such as in U.S. Pat. Nos. 6,532,778 B2, 6,952,940 B2, 8,770,635 B2 and US 2004/0007031A1, in which the handle may be in a free state or alternatively locked by a cylinder connected to a shell in the folded position.

The related panel locks have the following characteristics: after the handle is folded, the handle is in a free state unless it is further locked with a key through a lock core or a padlock, and for some large applications, the users are required to access multiple latches to lock multiple panels, which will increase considerably the time for the locking operation. Furthermore, when the panel lock is installed on a moving vehicle, the handle may shake and make noise if not locked in its folded position. In extreme cases, for example, under high acceleration or when encountering a bump on the road, the handle may be completely lifted under the action of inertial moment, which may cause undesirable consequences, for example, the latch member may be completely disengaged from the frame and released, such unstable state will eventually lead to premature failure of the latch, the worst case scenario, would be the door will then self-open. For those applications that require the handle to be folded and the latch member always compressed to seal the panel for waterproof requirements, the compression loss caused by the uncontrolled lifting of the handle will cause accelerated failure of the weather sensitive components inside the enclosure. In addition, once the handle is lifted at a certain angle, it forms a sharp protrusion sticking out of the panel and whether the panel lock is installed on a static equipment or a mobile vehicle, the handle becomes a serious safety hazard to passing by objects or people.

### SUMMARY

Regarding the abovementioned potential technical problems or safety hazards in the related art, an object of an embodiment of the present application is to provide a panel lock to overcome those issues.

To achieve the above purpose, an embodiment of the present application provides a panel lock including a shell, a rotating shaft, a locking tab, a handle, a latch hook and a first elastic spring. The rotating shaft is rotatably mounted in the shell. The locking tab is connected to and rotates along with the rotary shaft to realize unlocking and locking. The handle is rotatably mounted to the rotating shaft and has a first position being folded relative to the shell and a second position being lifted at a preset angle relative to the shell during rotation about a first axis perpendicular to the rotating shaft. The handle includes a latching groove and a guiding portion arranged at a side of the latching groove. The latch hook is rotatably mounted in the shell. The first elastic spring is arranged between the latch hook and the shell. When the handle is at the first position, the latch hook engages into the latching groove under the driving of the first elastic member to prevent the handle from leaving the first position; and during rotation of the handle from the second position to the first position, the guiding portion stretches the latch hook and guides the latch hook into the latching groove.

For the panel lock provided by the embodiments of the present application, automatic locking of the handle can be realized during the movement of the handle from the second position to the first position, thereby preventing the handle from disengaging and ensuring the reliability and safety of the panel lock. In addition, locking of the handle is realized synchronously in folding process, and no other locking action is required, which has better convenience and saves time.

In some embodiments, the latch hook has a third position, a fourth position and a fifth position during rotation, and wherein the latch hook at the third position is pressed into the latching groove under the driving of the first elastic member and makes the handle be fixed at the first position; the latch hook at the fourth position disengages from the latching groove and makes the handle be capable of disengaging from the first position; the latch hook rotates from the fourth position to the fifth position under the driving of the first elastic member when the handle is lifted, the fifth position is the same as the third position except the latch hook disengages from the latching groove and is below the latch groove; and during rotation of the handle from the second position to the first position, the guiding portion stretches the latch hook and guides the latch hook moving from the fifth position back to the third position.

In some embodiments, the panel lock further includes an unlocking member and a drive mechanism connected to the unlocking member, the unlocking member being movably mounted in the shell and driving the latch hook to move from the third position to the fourth position through the drive mechanism.

In some embodiments, the unlocking member includes a locking core which rotates under the driving of a key, and the drive mechanism includes a driven member rotating along with the locking core, a first slider slidably mounted in the shell and a first conversion unit arranged between the driven member and the first slider, the driven member drives the first slider to slide through the first conversion unit during rotation of the driven member, and the first slider drives the latch hook to move from the third position to the fourth position during sliding of the first slider.

In some embodiments, the latch hook includes a hook portion and a protrusion arranged around a rotating portion thereof, the hook portion matches with the latching groove, and the first slider pushes the protrusion during sliding of the first slider.

In some embodiments, the drive mechanism further includes a second elastic member, and the first slider is located at a position away from the latch hook under the action of the second elastic member.

In some embodiments, the first conversion unit includes a rotation protrusion and a slot, the rotation protrusion is formed on one of the driven member and the first slider, the slot is defined in the other one of the driven member and the first slider, and the rotation protrusion cooperates with the slot to implement the transformation from rotation to linear motion.

In some embodiments, the first conversion unit includes a gear and rack, the gear is mounted on one of the driven member and the first slider, the rack is mounted on the other one of the driven member and the first slider, and the gear meshes with the rack to implement the transformation from rotation to linear motion.

In some embodiments, the unlocking member includes an unlocking button being slidably mounted in the shell, and the drive mechanism includes a second slider and a second conversion unit, the second slider is slidably mounted in the shell, the second conversion unit is arranged between the unlocking button and the second slider, the unlocking button drives the second slider to slide through the second conversion unit, and the second slider drives the latch hook to move from the third position to the fourth position during sliding of the second slider.

In some embodiments, the second conversion unit includes an inclined face provided on the second slider and a driving end provided on the unlocking button, and the inclined face and the driving end are in sliding contact with each other to realize conversion of sliding directions of the unlocking button and the second slider.

In some embodiments, the unlocking member further includes a locking core which rotates under the driving of a key, and a locking member prevents the unlocking button from sliding when the locking core rotates to a target position.

In some embodiments, the latch hook is provided with a protrusion at a position surrounding a rotating portion thereof, an unlocking shaft is mounted in the shell, the unlocking shaft includes a cam portion for driving the latch hook to unlock the handle through the protrusion during rotation of the unlocking shaft, and the unlocking shaft includes an exposed external interface.

In some embodiments, at least one of the handle and the shell is provided with an ejection device, and the ejection device drives the handle which is disengaged from the latch hook to move to a middle position between the first position and the second position.

In some embodiments, the ejection device includes a first ejection mechanism, and the first ejection mechanism includes a mounting base arranged on the handle, a third elastic member, a spring cap and a boss formed on the shell, the spring cap is slidably mounted to the mounting base, the third elastic member is arranged between the spring cap and the mounting base and drives the spring cap to move to an outside of the mounting base, and the boss abuts against the spring cap when the handle moves to the first position.

In some embodiments, the ejection device further includes a second ejection mechanism, and the second ejection mechanism includes a spring bracket rotatably mounted to the handle and an ejecting spring mounted to the spring bracket, one end of the ejecting spring abuts against the handle, the other end of the ejecting spring abuts against the spring bracket, and the spring bracket abuts against the rotary shaft and compress the spring when the handle moves to the first position.

In some embodiments, when the handle at the second position rotates about the rotary shaft, the rotary shaft and the latching tab are driven to rotate from a locking position to an unlocking position to realize unlocking, or are driven to rotate from the unlocking position to the locking position to realize locking.

### BRIEF DESCRIPTION OF THE DRAWINGS

In order to illustrate technical solutions of embodiments of the present application more clearly, drawings that need to be used in the description of the embodiments will be briefly described below. It is obvious that the drawings described below are only some embodiments of the present application, and other drawings may be obtained from the drawings without any creative work to those skilled in the art, which should be in the scope of this application. In the following description, the same reference numerals refer to the same members.

FIG. 1 is a cross sectional view of a panel lock provided by an embodiment of the present application.

FIG. 2a is a schematic view of the panel lock provided by the embodiment of the present application with a handle thereof at a first position.

FIG. 2b is a schematic view of the panel lock provided by the embodiment of the present application with the handle at a second position.

FIG. 3 is a schematic view of a guide rail of the panel lock provided by the embodiment of the present application.

FIG. 4 is a schematic view of the handle of the panel lock provided by the embodiment of the present application.

FIG. 5 is a schematic view of a latch hook of the panel lock provided by the embodiment of the present application.

FIG. 6a is a cross sectional view of the panel lock provided by the embodiment of the present application with the latch hook at a third position.

FIG. 6b is a cross sectional view of the panel lock provided by the embodiment of the present application with the latch hook at a fourth position.

FIG. 6c is a cross sectional view of the panel lock provided by the embodiment of the present application with the latch hook at a fifth position.

FIG. 7 is a cross sectional view of the latch hook engaged into a latching groove of the handle.

FIG. 8 is a schematic view of a first unlocking assembly of the panel lock provided by the embodiment of the present application.

FIG. 9 is a schematic view of the first unlocking assembly at a rear side of a shell.

FIG. 10a is a schematic view of a driven member of the first unlocking assembly of FIG. 8.

FIG. 10b is a side view of the driven member of FIG. 10a.

FIG. 10c is another side view of the driven member of FIG. 10a.

FIG. 11a is a schematic view of a first slider of the first unlocking assembly of FIG. 8.

FIG. 11b is a top view of the first slider of FIG. 11a.

FIG. 12 is a cross sectional view showing a working state of the first unlocking assembly of the panel lock provided by the embodiment of the present application.

FIG. 13 is a schematic view of the first unlocking assembly of the panel lock provided by another embodiment of the present application.

FIG. 14a is a cross sectional view showing a first working state of the first unlocking assembly of FIG. 13.

FIG. 14b is a cross sectional view showing a second working state of the first unlocking assembly of FIG. 13.

FIG. 15 is a schematic view of a second unlocking assembly and a first sealing ring of the panel lock provided by the embodiment of the present application.

FIG. 16 is a schematic view of a portion of the shell corresponding to the second unlocking assembly.

FIG. 17 is a cross sectional view showing a working state of the second unlocking assembly of the panel lock provided by the embodiment of the present application.

FIG. 18 is an assembled view of the panel lock and an external module.

FIG. 19 is a schematic view of the rear side of the shell of the panel lock provided by the embodiment of the present application.

FIG. 20 is a schematic view of the rear cover of the panel lock provided by the embodiment of the present application.

FIG. 21 is a schematic view of a second sealing ring of the panel lock provided by the embodiment of the present application.

FIG. 22 is a schematic view of the second ejection mechanism of the panel lock provided by the embodiment of the present application.

FIG. 23a is a schematic view of a spring bracket of the second ejection mechanism of FIG. 22.

FIG. 23b is a side view of the spring bracket of FIG. 23a.

FIG. 24a is a cross sectional view showing a working state of the second ejection mechanism of FIG. 22.

FIG. 24b is a cross sectional view showing another working state of the second ejection mechanism of FIG. 22.

FIG. 25 is a schematic view of a sleeve of the lock panel provided by the embodiment of the present application.

### DESCRIPTION OF THE EMBODIMENTS

For better illustrating the technical means, creative features, objects and effects of the present application, detailed description will be given for the embodiments provided by the present application with reference to the append drawings. Obviously, the described embodiments are only a part of the embodiments, and not all of the embodiments of the present application. Based on the embodiments of the present application, all other embodiments obtained by those skilled in the art without any creative work should be in the scope of this application.

It should be noted that when an element is referred to as being “fixed to” or “disposed in/at” another element, it may be directly or indirectly on the other element. When an element is referred to as being “connected to” another element, it may be directly or indirectly connected to the other element.

It should be understood that oriental or positional relationships indicated by terms “length”, “width”, “upper”, “lower”, “front”, “rear”, “left”, “right”, “vertical”, “horizontal”, “top”, “bottom”, “inner”, “outer” and the like are only intended to facilitate the description of the present disclosure and simplify the description based on oriental or positional relationships shown in the accompanying drawings, not to indicate or imply that the apparatus or element referred must have a specific orientation, is constructed and operated in a specific orientation, and therefore cannot be understood as a limitation of the present disclosure.

In addition, terms “first” and “second” are only used for descriptive purposes, and cannot be understood as indicating or implying relative importance or implicitly indicating the number of technical features indicated. Therefore, features defined with “first” and “second” may explicitly or implicitly include one or more of these features. In the description of the present disclosure, “a plurality of” refers to two or more than two, unless otherwise particularly defined.

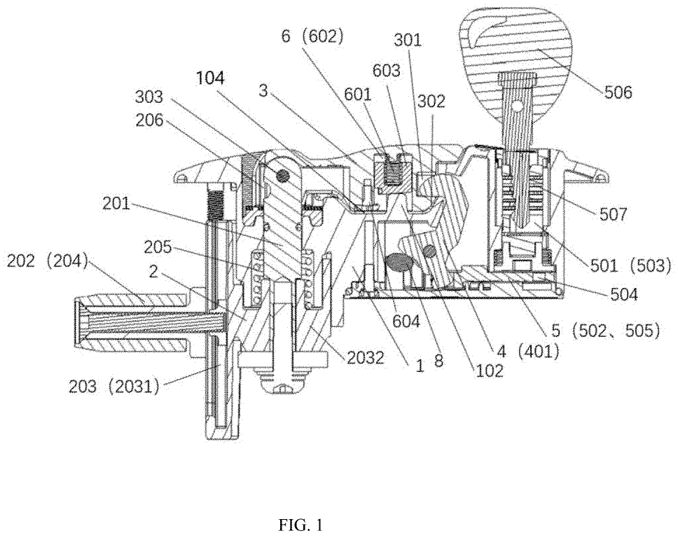

FIG. 1 is a cross sectional view of a panel lock provided by an embodiment of the present application. As shown in FIG. 1, the panel lock includes a shell 1, a first locking assembly 2, a handle 3, a second locking assembly 4 and a first unlocking assembly 5. The panel lock includes two opposite sides, i.e. the front side and the rear side. After the installation of the panel lock, the rear side of the panel lock is close to the door, while the front side of the panel lock faces towards the user for operation. The shell 1 defines a first groove 101 in a side thereof facing to the front side of the panel lock, and a second groove 104 is defined at a bottom of the first groove 101.

The first locking assembly 2 is used to realize locking and unlocking of the door on which the panel lock is installed. The first locking assembly 2 includes a first rotary shaft 201 and a locking tab 202. The first rotary shaft 201 is rotatably mounted in the shell 1 about its longitudinal axis and extends through the shell 1. The locking tab 202 is connected to a portion of the first rotary shaft 201 extending to the rear side of the shell 1. The first locking assembly 2 realizes locking and unlocking of the door on which the panel lock is installed through rotation of the locking tab 202.

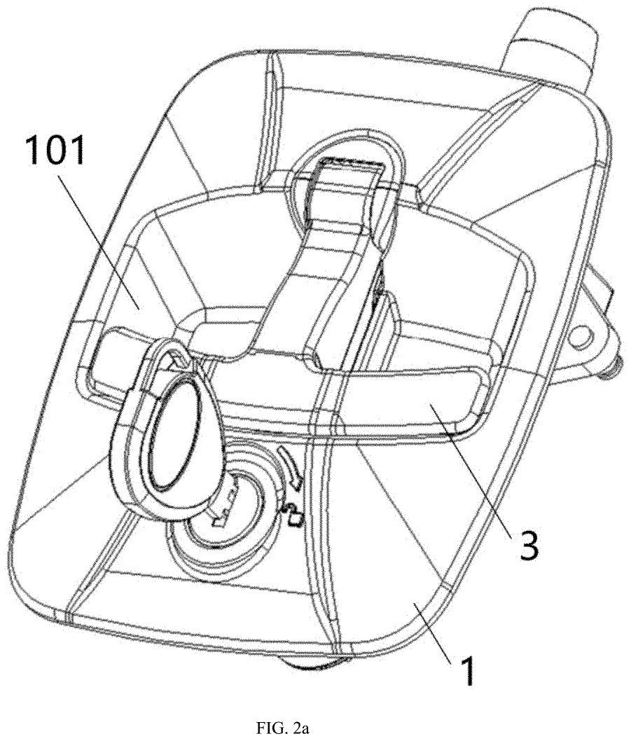

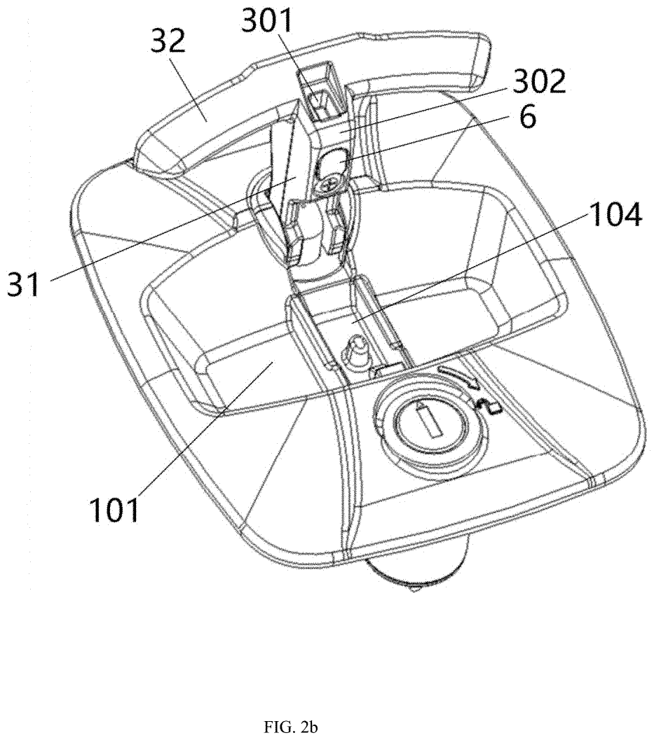

The handle 3 is mounted onto a portion of the first rotary shaft 201 extending to the front side of the shell 1, and is rotatably mounted to an end of the first rotary shaft 201 about a first axis 303. The first axis 303 is perpendicular to the first rotary shaft 201 and its longitudinal axis. The handle 3 may rotate about the first axis 303 relative to the first rotary shaft 201, or may rotate along with the first rotary shaft 201 about its longitudinal axis. Referring to FIG. 2a and FIG. 2b, during rotation of the handle 3 about the first axis 303, the handle 3 may move to a first position that the handle 3 is folded in the first groove 101 (as shown in FIG. 2a) and a second position that the handle is lifted to a certain angle with respect to the shell 1 (as shown in FIG. 2b). The handle 3 at the second position may be collinear with the first rotary shaft 201, facilitating a twisting operation of the handle 3 together with the first rotary shaft 201.

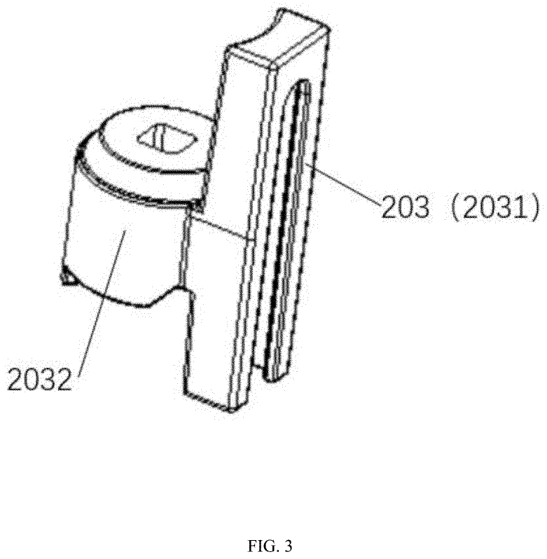

Referring to FIG. 1 and FIG. 3, the locking tab 202 may be an adjustable locking tab, and includes a guide rail 203 and a locking shaft 204. The locking shaft 204 is vertically installed on the guide rail 203. The guide rail 203 includes a slide body 2031 and a fixing ring 2032 mounted around the first rotary shaft 201. The guide rail 203 is used to adjust in a sliding way an installation position of the locking shaft 204 in the longitudinal direction of the first rotary shaft 201. Such design makes the panel lock applicable to doors with different thicknesses, which increases the versatility of the present panel lock.

In one embodiment, the guide rail 203 further includes a threaded shaft mounted on the slide body 2031, and an end of the locking shaft 204 on the slide body 2031 is provided with a thread matching with the threaded shaft, which allows the locking shaft 204 to move along the guide rail 203 in a sliding way when the rotating threaded shaft is mounted loose. When the position of the locking shaft 204 is adjusted and need to be set at such position, the threaded shaft can be twisted and tightened, locking conveniently the locking shaft 204 into that position.

During the use of the panel lock, the user firstly grabs the handle 3 to lift it from the first position, i.e., folded in the first groove 101, to the second position, i.e., at a certain angle with respect to the shell 1, and then rotates the handle 3 to drive the first rotary shaft 201 to rotate, thereby driving the locking tab 202 to rotate to realize locking or unlocking. In order to facilitate user's operation, the handle 3 may be any structure that is convenient for holding and rotating, such as T-shaped or an L-shaped. In this embodiment, a T-shaped handle is taken as an example.

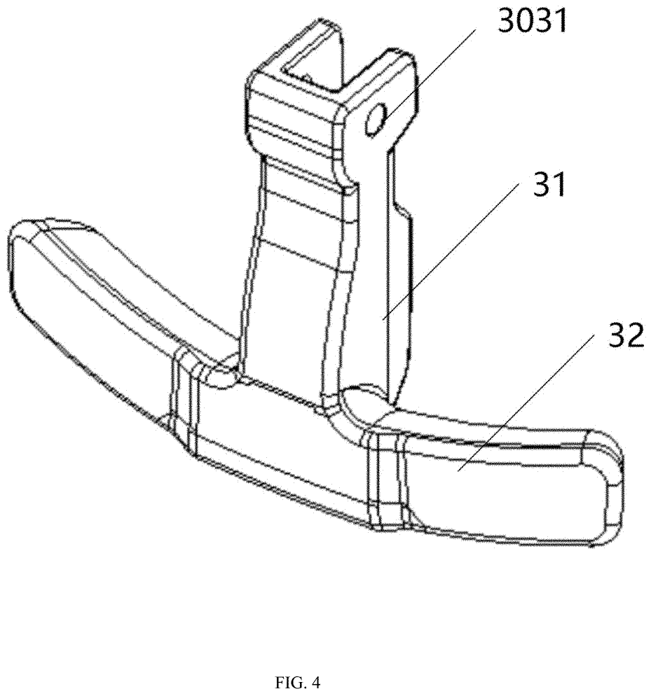

FIG. 4 is a schematic view of the handle of the panel lock provided by the embodiment of the present application. Referring to FIG. 1 to FIG. 4, the handle 3 is generally T-shaped, and includes a first handle portion 31 and a second handle portion 32. Both the first handle portion 31 and the second handle portion 32 are elongated. The longitudinal direction of the first handle portion 31 is perpendicular to the first axis 303. One end of the first handle portion 31 along the longitudinal direction thereof defines a first axle hole 3031 therein, and the other end of the first handle portion 31 along the longitudinal direction thereof is connected to the second handle portion 32. The first handle portion 31 is rotatably mounted to the first rotary shaft 201 through the first axle hole 3031 and the first axis 303 extending through the first axle hole 3031. The longitudinal direction of the second handle portion 32 is perpendicular to the longitudinal direction of the first handle portion 31, and the first handle portion 31 is connected to a middle portion of the second handle portion 32, thereby forming the T-shaped handle. For facilitating hand-holding operation, the second handle portion 32 may be curved along the longitudinal direction thereof.

The handle 3 includes opposite inner side and outer side. In this specification, a side of the handle 3 adjacent to the shell 1 during movement of the handle 3 between the first position and the second position is defined as the inner side, and a side of the handle 3 opposite to the inner side is defined as the outer side.

The handle 3 includes a latching groove 301 and a guiding portion 302. The latching groove 301 has an aperture communicating with the outside, and an open direction is substantially parallel to an extending direction of the first handle portion 31. The guiding portion 302 is located at a side of the latching groove 301 close to the shell 1. That is, a portion of the handle 3 between a periphery of the latching groove 301 and the inner side of the handle 3 is the guiding portion 302. During movement of the handle 3 from the second position to the first position, the guiding portion 302 is capable of pushing a latch hook 401 to move against an elastic member and guiding the latch hook 401 into the latching groove 301 (details are described below).

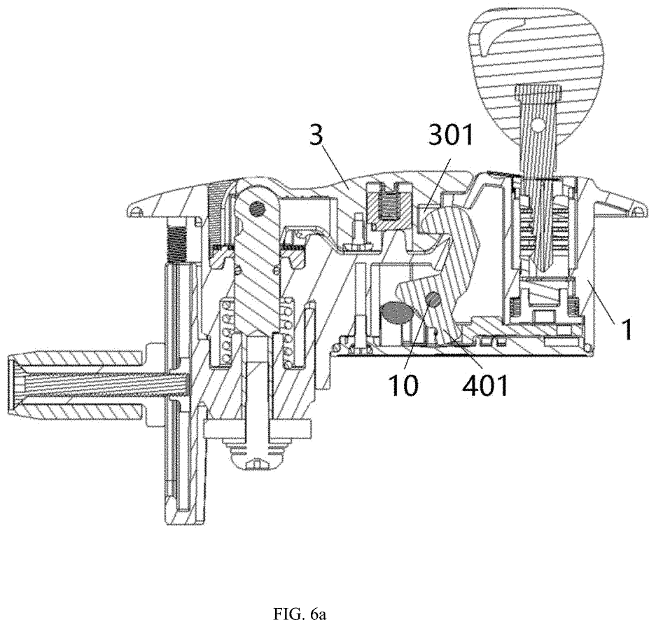

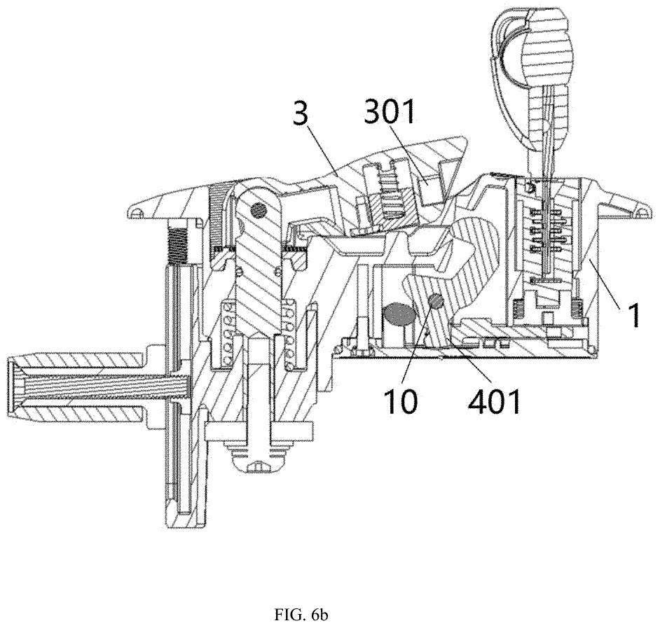

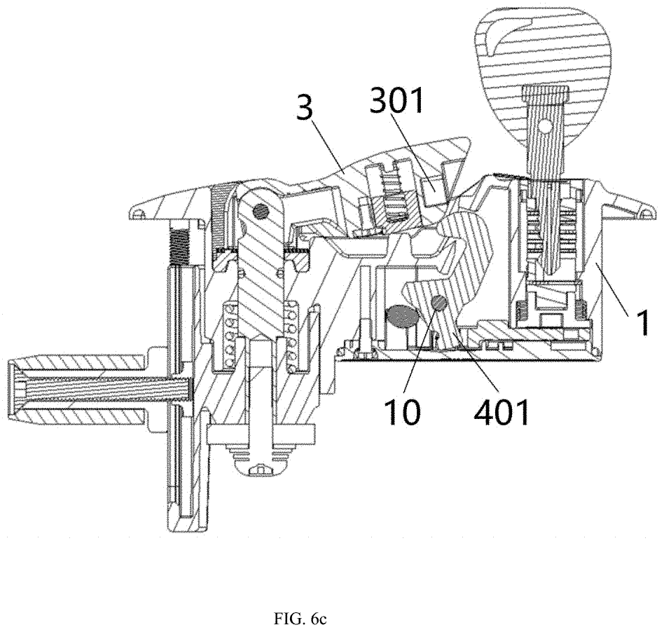

The second locking assembly 4 is used to lock the handle 3 at the first position, and includes the latch hook 401 and a first elastic member 402. The latch hook 401 is rotatably mounted in the shell 1 through a second rotary shaft 10 (as shown in FIGS. 6a to 6c). The second rotary shaft 10 is perpendicular to the first rotary shaft 201. It should be noted that since the position of the first axis 303 changes during the rotation of the first rotary shaft 201, the first axis 303 may be parallel to the second rotary shaft 10 when the handle 3 is at the first position.

The first elastic member 402 is arranged between the latch hook 401 and the shell 1. In some embodiments, the first elastic member 402 may be a torsion spring sleeved on the second rotary shaft 10. One end of the first elastic member 402 is connected to the shell 1, and the other end of the first elastic member 402 is connected to the latch hook 401. Under the action of the first elastic member 402, the latch hook 401 rotates about the second rotary shaft 10.

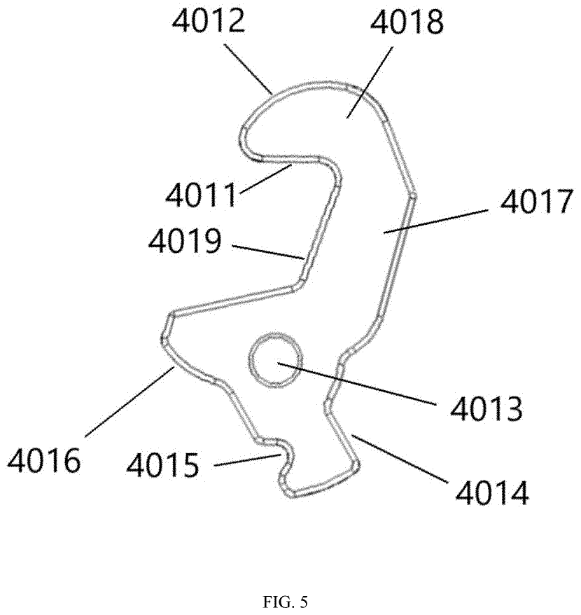

FIG. 5 is a schematic view of the latch hook of the panel lock provided by the embodiment of the present application. As shown in FIG. 5, the latch hook 401 is a hook-like structure, and includes a second axle hole 4013 for mounting the second rotary shaft 10, a first protrusion 4017, a second protrusion 4016, a third protrusion 4014 and a hook portion 4018 connected to the first protrusion 4017. The first protrusion 4017, the second protrusion 4016 and the third protrusion 4014 are convex structures extending along a radial direction of the second axle hole 4013, and are arranged around the second axle hole 4013 and evenly spaced from each other.

The hook portion 4018 extends from a top end of the first protrusion 4017 towards the second protrusion 4016 to form the hook-like structure. The hook portion 4018 includes a first lateral side 4011 and a second lateral side 4012, wherein the first lateral side 4011 is closer to the second protrusion 4016 than the second lateral side 4012. That is, for the hook-like structure, the first lateral side 4011 is an inner surface, and the second lateral side 4012 is an outer surface. A mounting groove 4015 is defined in a side of the third protrusion 4014 interacting with the torsion spring, i.e., the first elastic member 402.

The latch hook 401 is rotatably mounted in the shell 1, and may be rotated to a third position, a fourth position and a fifth position. FIGS. 6a to 6C are cross section views of the panel lock provided by the embodiment of the present application with the latch hook at different positions. As shown in FIG. 6A, the first elastic member 402 is arranged between the latch hook 401 and the shell 1, driving the latch hook 401 to move to the third position. When the latch hook 401 is at the third position, the hook portion 4018 is pressed into the latching groove 301 by the first elastic member 402, which makes the handle 3 be fixed at the first position and maintained securely in a folded state.

As shown in FIG. 6B, the latch hook 401 at the third position rotates clockwise around the second rotary shaft 10 until it disengages from the latching groove 301, which makes the handle 3 disengage from the first position and move freely between the first position and the second position. A position of the latch hook 401 at this time is defined as the fourth position.

As shown in FIG. 6C, when the handle 3 is lifted from the first position, the latch hook 401 rotates counterclockwise about the second rotary shaft 10 to the fifth position under the driving force of the first elastic member 402. The fifth position of the latch hook 401 is the same as the third position. The latch hook 401 is engaged into the latch groove 301 when the latch hook 401 at the third position, in contrast to the latch hook 401 is disengaged from the latch groove 301 and is below the latch groove 301 when the latch hook 401 at the fifth position.

After the user has locked or unlocked the door, and to complete the operation of the panel lock, the handle 3 needs to be rotated and folded from the second position to the first position. When the handle 3 moves from the second position to the first position, and before it contacts the latch hook 401, the latch hook 401 is maintained at the fifth position under the action of the first elastic member 402. As soon as the handle 3 contacts the latch hook 401 and under the pressure of the guiding portion 302 of the handle 3, the latch hook 401 is forced to rotate reversely towards the fourth position against the elastic force of the first elastic member 402. As the handle 3 continues to move towards the first position, the latch hook 401 rides on the guiding portion 302 until it reaches a point that it can finally enter the latching groove 301 under the driving force of the first elastic member 402, realizing the secure locking of the handle 3.

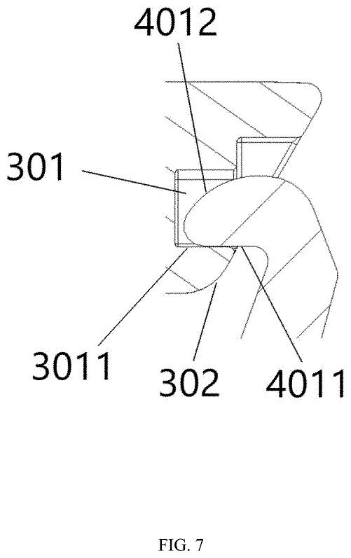

FIG. 7 is an assembled view of the latch hook and handle of FIG. 6a. As shown in FIG. 7, the hook portion 4018 of the latch hook 401 extends into the latching groove 301 of the handle 3, realizes the locking of the handle 3 by the latch hook 401 by means of an engagement of a groove wall 3011 of the latching groove 301 and the first lateral side 4011 of the hook portion 4018.

During the reverse rotation of the latch hook 401 pushed by the handle 3, the guiding portion 302 abuts against the second lateral side 4012 of the latch hook 401 and moves smoothly along the second lateral side 4012 while remaining in contact. Due to the arc shape of the second lateral side 4012, the guiding portion 302 of the handle 3 pushes away the latch hook 401 from the fifth position to the fourth position when the second lateral side 4012 is pressed down, thereby driving the latch hook 401 to rotate reversely. To facilitate this motion, the guiding portion 302 may be designed to be an arc-shaped structure which induces less resistance to the second lateral side 4012 during movement. Similarly, the second lateral side 4012 may be an arc surface to reduce the friction force between the guiding portion 302 and the second lateral side 4012.

It can be seen from the above description that with the panel lock provided by the embodiment of the present application, automatic locking of the handle 3 can be realized during the movement of the handle 3 from the second position to the first position, thereby preventing the handle 3 from disengaging from the first groove 101, and ensuring the reliability and safety of the panel lock. In addition, locking of the handle 3 is realized synchronously in folding process, and no other locking action is required, which has better convenience and saves time.

When the handle 3 is locked by the second locking assembly 4, the handle 3 needs to be unlocked if it needs to be used again. In view of this, the panel lock provided by the embodiment of the present application further includes an unlocking device, which can drive the latch hook 401 to rotate reversely to move from the third position to the fourth position, so that the hook portion 4018 of the latch hook 401 is disengaged from the latching groove 301 of the handle 3 to realize unlocking of the handle 3 by the latch hook 401.

For the panel lock provided by the embodiment of the present application, the second locking assembly 4 cooperates with the handle 3 to lock the handle 3, and the unlocking device cooperates with the locking assembly 4 to unlock the handle 3. Such design enables the handle 3 to be stably locked in the first groove 101 and the second groove 104 of the shell 1 in the nonworking state, which avoids the influence of unstable environment on the shaking of the handle 3 and enhances the safety of the panel lock, meeting the requirements of locks under different working conditions. Further, the unlocking device is provided to ensure normal use of the panel lock.

The unlocking device includes the first unlocking assembly 5, which includes an unlocking member 501 and a drive mechanism 502 connected to the unlocking member 501. The unlocking member 501 is movably mounted in the shell 1 to drive the drive mechanism 502 to move. The moving drive mechanism 502 acts on the third protrusion 4014 of the latch hook 401, driving the latch hook 401 to rotate reversely about the second rotary shaft 10 by means of pushing the third protrusion 4014, thereby the latch hook 401 moving to the fourth position to realize unlocking of the latch hook 401. The unlocking member 501 includes an operation end exposed toward the front side of the shell 1, and the user can unlock the handle 3 by operating the operation end.

After unlocking of the handle 3, the user can lift the handle 3 to the second position and rotate the handle 3 to drive the first rotary shaft 201 to rotate, the first rotary shaft 201 drives the locking tab 202 to rotate to realize locking and unlocking of the panel lock. In one embodiment, when the user lifts the handle 3 from the first position to the second position, the locking tab 202 moves downward to release the pressure on the door, and when the handle 3 is rotated around the first rotary shaft 201 axis, it drives the first rotary shaft 201 to rotate as well which in turn, drives the locking tab 202 to rotate, so that the locking tab 202 is moved to the unlocking position, thereby realizing a switch between the locking position and the unlocking position of the panel lock.

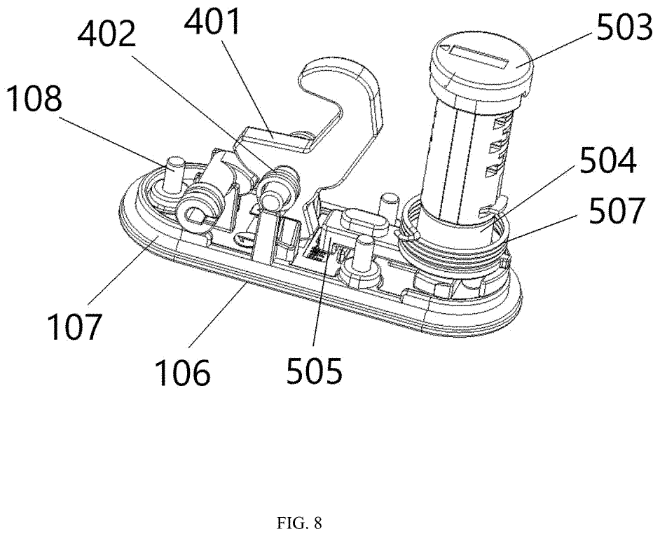

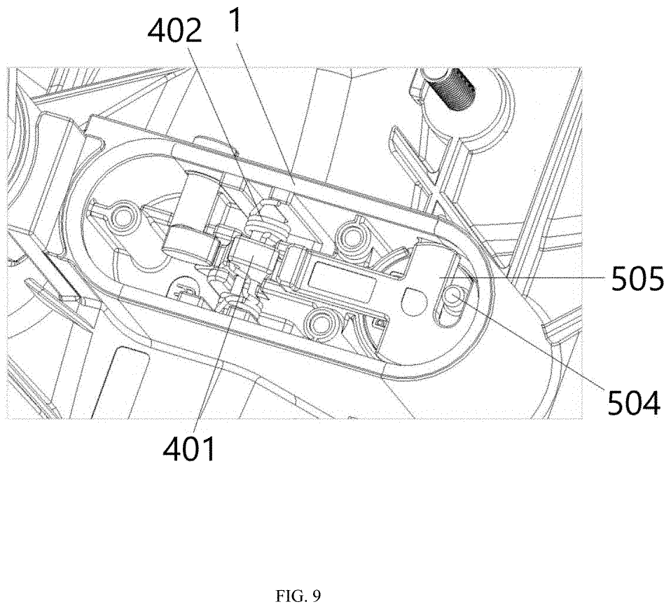

FIG. 8 is a schematic view of the first unlocking assembly of the panel lock provided by the embodiment of the present application, and FIG. 9 is a schematic view of the first unlocking assembly at the rear side of the shell. As shown in FIG. 8 and FIG. 9, the unlocking member 501 includes a locking core 503, and the drive mechanism 502 includes a driven member 504, a first slider 505 and a first conversion unit. The locking core 503 is vertically mounted on the front surface of the shell 1, and can rotate under the action of a key 506. The driven member 504 is arranged at a bottom of the locking core 503, and can rotate along with the locking core 503. The first slider 505 is slidably mounted in the shell 1, and contacts the third protrusion 4014 of the latch hook 401 during the sliding process, and pushes the latch hook 401 to move to the fourth position against the force of the first elastic member 402.

The first conversion unit is arranged between the driven member 504 and the first slider 505, and converts the rotation of the driven member 504 to the sliding motion of the first slider 505. The latch hook 401 moves to the fourth position under the driving action of the first slider 505.

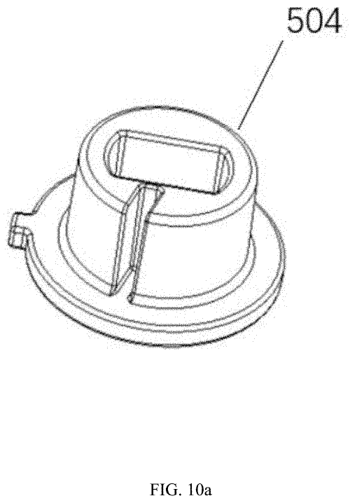

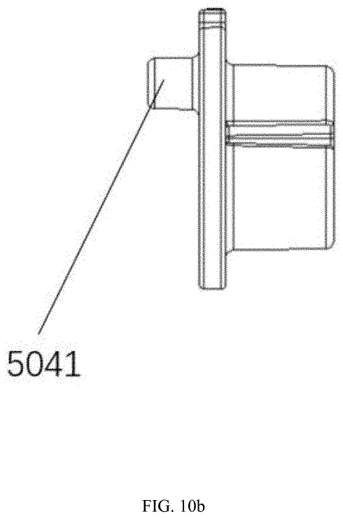

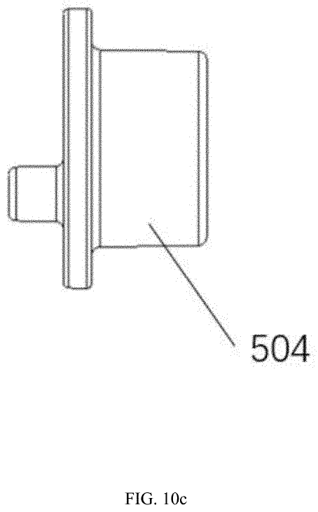

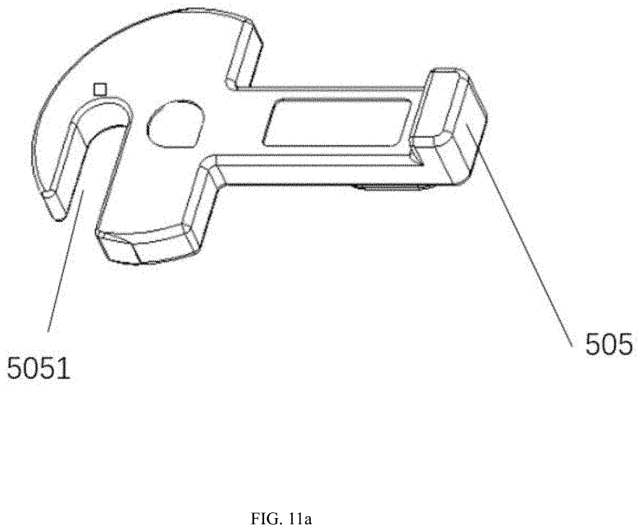

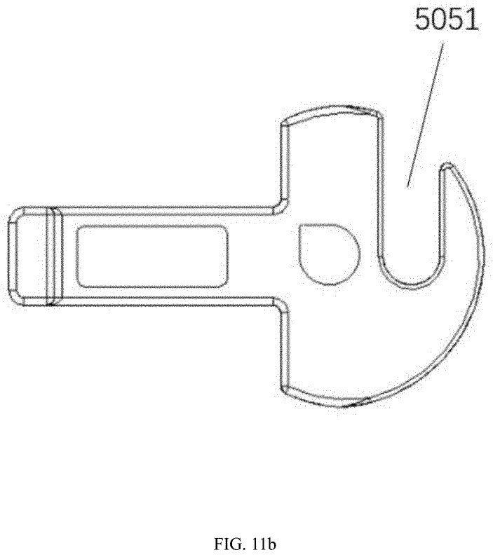

FIG. 10a is a schematic view of the driven member of the first unlocking assembly of FIG. 8; FIG. 10b is a side view of the driven member of FIG. 10a; FIG. 10c is another side view of the driven member of FIG. 10a; FIG. 11a is a schematic view of a first slider of the first unlocking assembly of FIG. 8; and FIG. 11b is a top view of the first slider of FIG. 11a. As shown in FIG. 8 to FIG. 11b, the first conversion unit includes a rotation protrusion 5041 protruding from the driven member 504 and a slot 5051 defined in the first slider 505. The rotation protrusion 5041 and the slot 5051 cooperate with each other to implement the transformation from rotation to linear motion.

Obviously, positions of the rotation protrusion 5041 and the slot 5051 can be interchanged. In addition, the first conversion unit can be any rotation-linear motion conversion structures, which will not be listed here. For example, the first conversion unit may include a gear provided on one of the driven member 504 and the first slider 505, and a rack provided on the other one of the driven member 504 and the first slider 505. The gear and rack mesh with each other to implement the transformation from rotation to linear motion.

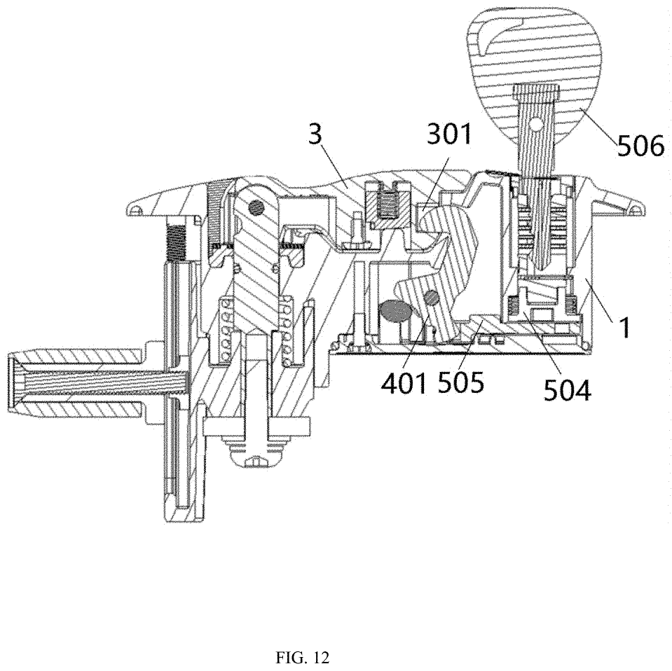

FIG. 12 shows a working state of the first unlocking assembly of the panel lock provided by the embodiment of the present application. As shown in FIG. 12, the working principle of the first unlocking assembly 5 is: the key 506 is inserted in the locking core 503 and then turned by the user, the driven member 504 at the bottom of the locking core 503 is driven to rotate along with the locking core 503, and rotation of the driven member 504 is converted to straight movement of the first slider 505 under the action of the first conversion unit, the first slider 505 thus slides to contact the third protrusion 4014 of the latch hook 401 and pushes the latch hook 401 to move to the fourth position against the force of the first elastic member 401 to realize unlocking of the handle 3.

The drive mechanism 502 further includes a restoring spring 507, which is preferably a torsion spring and sleeved on the driven member 504 to provide torque to restore the rotated driven member 504 to the initial position. Since the locking core 503 and the driven member 504 are designed in linkage, the restoring spring 507 can restore the released locking core 503 to the initial position through the driven member 504.

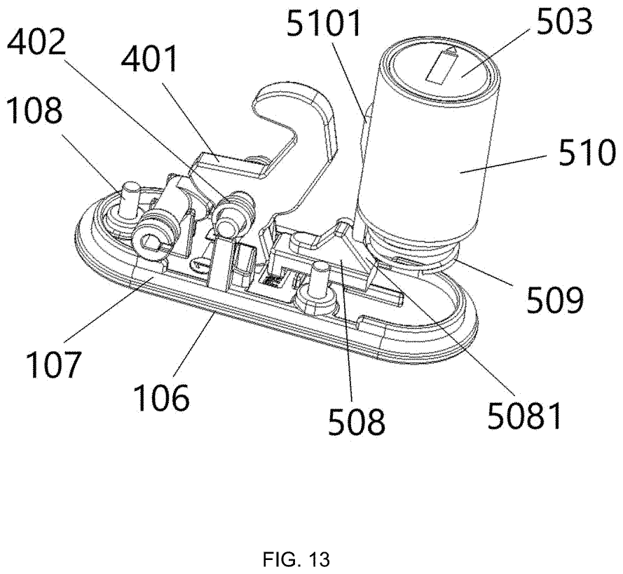

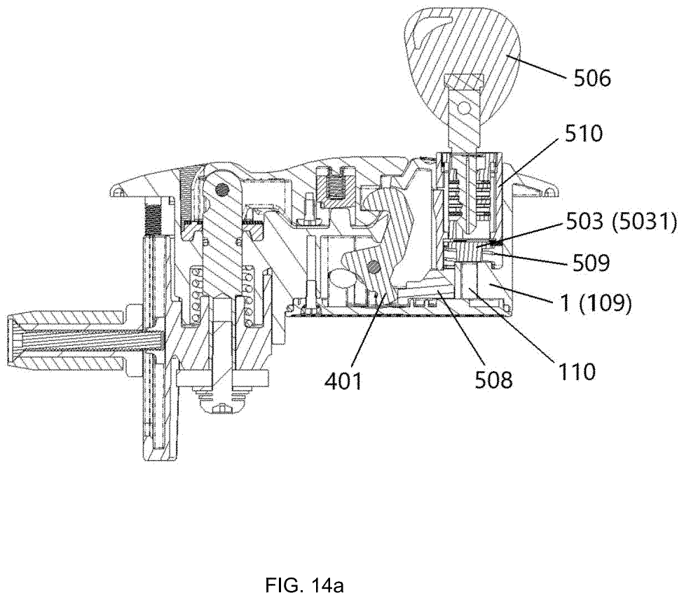

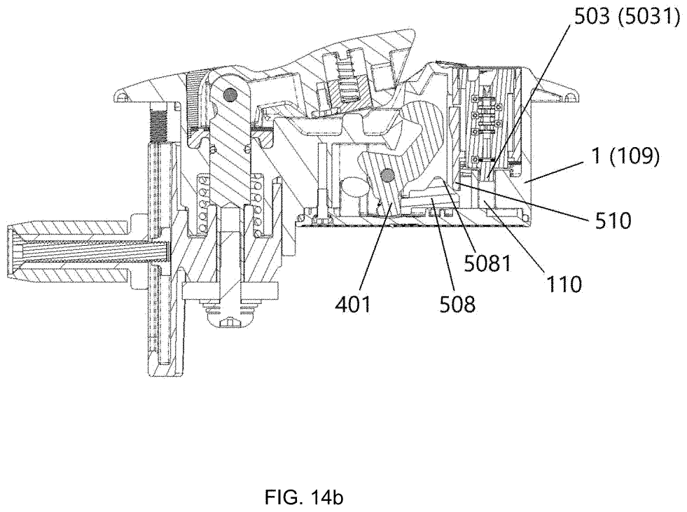

FIG. 13 is a schematic view of the first unlocking assembly of the panel lock provided by another embodiment of the present application. FIG. 14a and FIG. 14b show the first unlocking assembly of FIG. 13 in different working states. For the first unlocking assembly 5 shown in FIG. 13, FIG. 14a and FIG. 14b, the unlocking member 501 includes a locking core 503 and an unlocking button 510, and the drive mechanism 502 includes a second slider 508 and a second conversion unit.

The unlocking button 510 is provided with a sliding protrusion 5101 on an outer circumferential surface thereof, and is arranged in the shell 1 and slidably along the first axis by the sliding protrusion 5101. The locking core 503 is inserted into the unlocking button 510, i.e., the unlocking button 510 is mounted around the locking core 503. The locking core 503 can rotate around the central axis parallel to the first rotary shaft 201 in the unlocking button 510, and can slide along with the unlocking button 510 through internal mating structures.

The bottom of the locking core 503 is provided with a limiting protrusion 5031, and the shell 1 defines a limiting groove 110 corresponding to the limiting protrusion 5031. The limiting protrusion 5031 is aligned with the limiting groove 110 after rotating to a preset angle along with the locking core 503. The limiting protrusion 5031 aligned the limiting groove 110 can enter the limiting groove 110 and slide along the first axis in the limiting groove 110. Before the limiting protrusion 5031 rotates to the preset angle, the limiting protrusion 5031 deviates from the limiting groove 110 and cannot enter the limiting groove 110, thus the limiting protrusion 5031 is restricted above the limiting groove 110. The shapes of the limiting protrusion 5031 and the limiting groove 110 may be elongated strip, cross, square, triangle, etc.

A compression spring 509 is provided between the bottom of the locking core 503 and the shell 1. The compression spring 509 drives the limiting protrusion 5031 to move to a position disengaged from the limiting groove 110. In other words, when the limiting protrusion 503 aligns with the limiting groove 110 and enters the limiting groove 110, the elastic force of the compression spring 509 needs to be overcome.

The second slider 508 is slidably mounted in the shell 1, and contacts the third protrusion 4014 of the latch hook 401 during the sliding process, so as to push the latch hook 401 to move to the fourth position against the elastic force of the first elastic member 402.

The second conversion unit is arranged between the second slider 508 and the unlocking button 510 to convert the sliding motion of the unlocking button 510 into the sliding motion of the second slider 508. In this embodiment, the second conversion unit includes an inclined face 5081 provided on the second slider 508 and a driving end provided at the bottom of the unlocking button 510. The inclined face 5081 is a slope inclined along the sliding direction between the second slider 508 and the unlocking button 510, and the driving end of the unlocking button 510 abuts against the inclined face 5081. During the movement of the unlocking button 510, conversion is completed by the cooperation of the driving end and the inclined face 5081. Obviously, to reduce the friction force with the inclined face 5081, the driving end may be a smooth curved surface structure or an inclined surface structure corresponding to the inclined face 5081. In addition, the inclined face and the driving end may be replaced by matching curved surfaces.

The working principle of the first unlocking assembly 5 is as follows: please refer to FIG. 14a, the limiting groove 110 and the limiting protrusion 5031 are not aligned in general, and thus the limiting protrusion 5031 cannot move if the unlocking button 510 is pressed. Referring to FIG. 14b, after the locking core 503 is rotated by the key 506 to make the limiting groove 110 be aligned with the limiting protrusion 5031, the unlocking button 510 is pressed to make the locking core 503 to move downward along with the unlocking button 510. The driving end of the unlocking button 510 drives the second slider 508 to slide toward the latch hook 401 through the inclined face 5081, and the second slider 508 contacts the third protrusion 4014 of the latch hook 401 and pushes the latch hook 401 to move to the fourth position against the force of the first elastic member 402, thereby realizing unlocking of the handle 3. After unlocking of the handle 3, the unlocking button 510 is released, and the compression spring 509 drives the limiting protrusion 5031 to disengage from the limiting groove 110.

In the above embodiments, the locking core 503 acts as the unlocking member, or the locking core 503 and the unlocking button 510 cooperatively act as the unlocking member. Obviously, the unlocking member may be formed by the unlocking button 510, without the locking core 503. In this way, the unlocking operation of the handle 3 can be realized without rotating the key, making the operation quicker and more convenient for those units that do not require secure access.

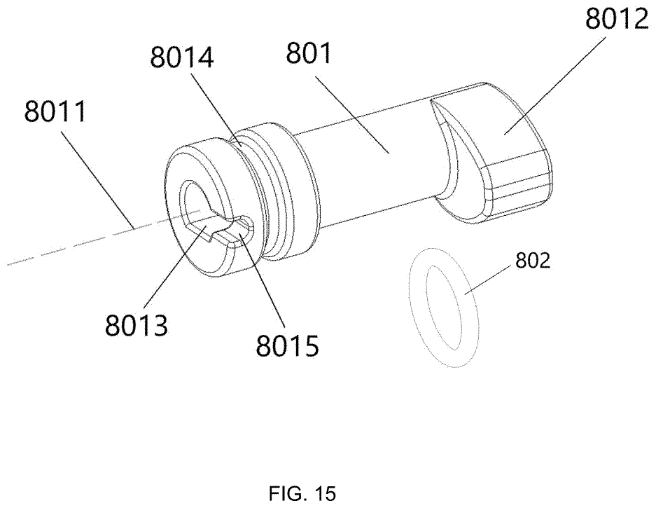

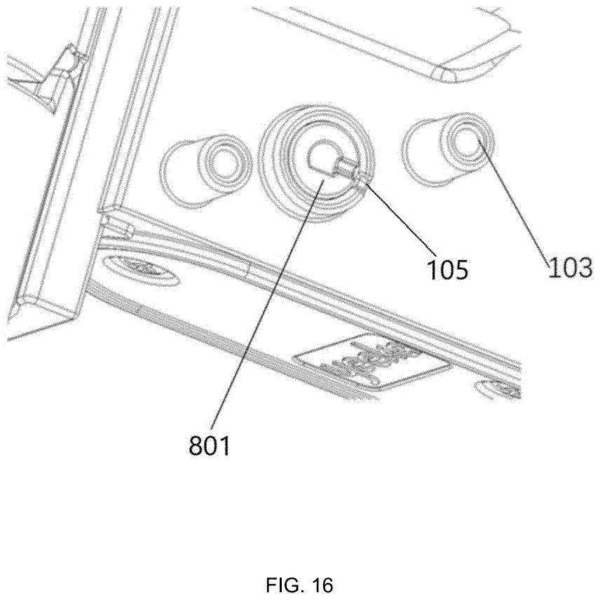

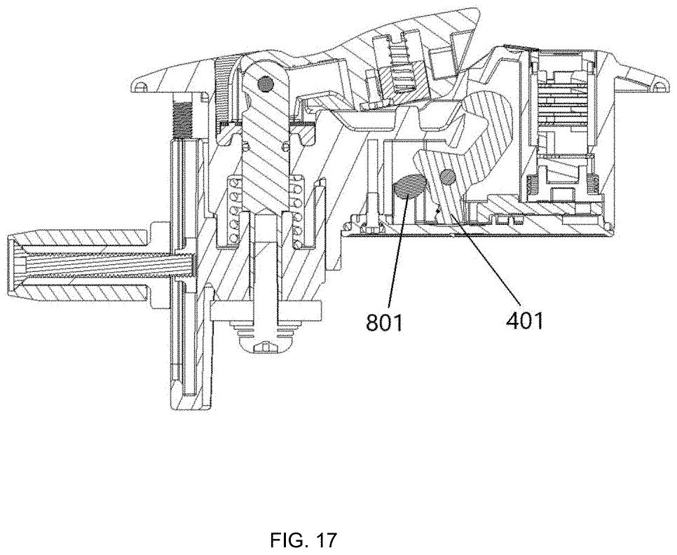

In an alternative embodiment, the unlocking device of the panel lock may further include a second unlocking assembly 8. FIG. 15 is a schematic view of the second unlocking assembly of the panel lock provided by the embodiment of the present application, FIG. 16 is a schematic view of a portion of the shell corresponding to the second unlocking assembly, and FIG. 17 shows a working state of the second unlocking assembly of the panel lock provided by the embodiment of the present application. As shown in FIG. 15 to FIG. 17, the second unlocking assembly 8 includes an unlocking shaft 801 and a first sealing ring 802. The unlocking shaft 8 is rotatably mounted in the shell 1 about a third axis. That is, the unlocking shaft 8 is parallel to the rotation direction of the latch hook 401.

The unlocking shaft 8 is a shaft-shaped structure extending along the cam axis 8011, and includes a cam portion 8012, a sealing groove 8014 and a driving joint 8013 arranged along the cam axis 8011. During assembly, the cam portion 8012 is at a position that can contact the second projection 4016 of the latch hook 401 during rotation. The cam portion 8012 drives the latch hook 401 to rotate through the action onto the second projection 4016 to realize disengagement of the latch hook 401 from the latching groove 301 of the handle 3, thereby unlocking the handle 3.

The driving joint 8013 extends beyond the shell 1, and a first sealing ring 802 is accommodated in the sealing groove 8014 to seal a connection positon of the shell 1 and the unlocking shaft 8, ensuring the tightness of the panel lock. The driving joint 8013 includes an external interface for connecting an external module 9.

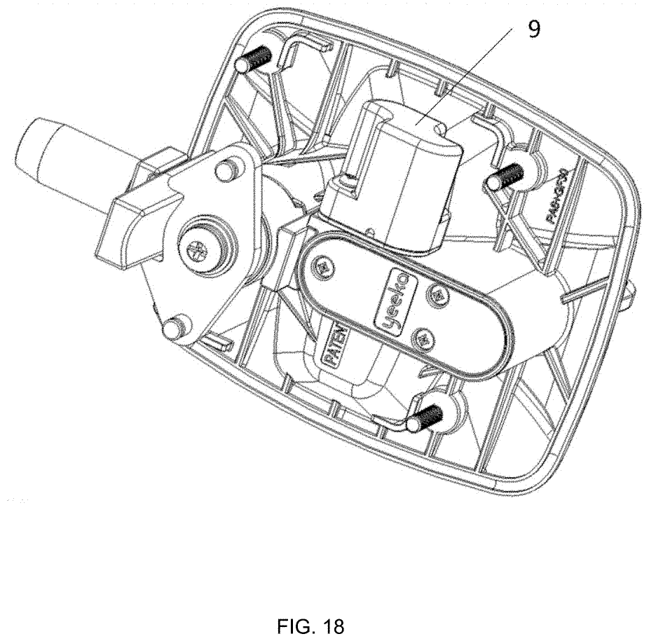

FIG. 18 is an assembled view of the panel lock and the external module. By docking the external module 9 with the first drive joint 8013, the external module 9 can drive the unlocking shaft 8 to rotate, so that the latch hook 401 is driven to rotate reversely through the cooperation of the cam portion 8012 and the second projection 4016, so as to realize disengagement of the latch hook 401 from the latching groove 301 of the handle 3 and complete the unlocking of the handle 3. It can be seen that the panel lock provided in the embodiments of the present application reserves the external interface for installing the external module 9, which can realize remotely controlled, mechanical or electronic unlocking of the handle 3.

The rear side of the shell 1 is provided with a mounting post 103 for inserting the external module 9. An interface of the driving joint 8013 is a hole defined in an end of the unlocking shaft 8, and a first alignment label 8015 is formed at a periphery of the hole. The shell 1 forms a second alignment label 105 corresponding to the first alignment label 8015. The alignment of the external module 9 and the shell 1 is obtained by the first alignment label 8015 and the second alignment label 105.

The panel lock provided in the embodiment of the present application includes the external module 9, so that the handle 3 of the panel lock can be unlocked by external related equipment. The external module 9 just needs to drive the unlocking shaft 8 to rotate to unlock the handle 3 after assembled with the mounting post 103, which increases the expandability of the panel lock.

In addition, by providing the first sealing ring 802, a sealing performance of the panel lock is ensured while retaining the external interface.

Further, the unlocking shaft 8 may also be provided with a position sensor for feeding back a rotation angle of the unlocking shaft 8 to the external module 9. The external module 9 can adjust the state of the unlocking shaft 8 in real-time according to the rotation angle of the unlocking shaft, so as to avoid that too large or too small rotation angle of the unlocking shaft 8 influences the opening or closing of the panel lock.

It should be noted that the first unlocking assembly 5 and the second unlocking assembly 8 can work separately. Therefore, in other embodiments, the panel lock may only include the first unlocking assembly 5, or only include the second unlocking assembly 8, or include both the first unlocking assembly 5 and the second unlocking assembly 8.

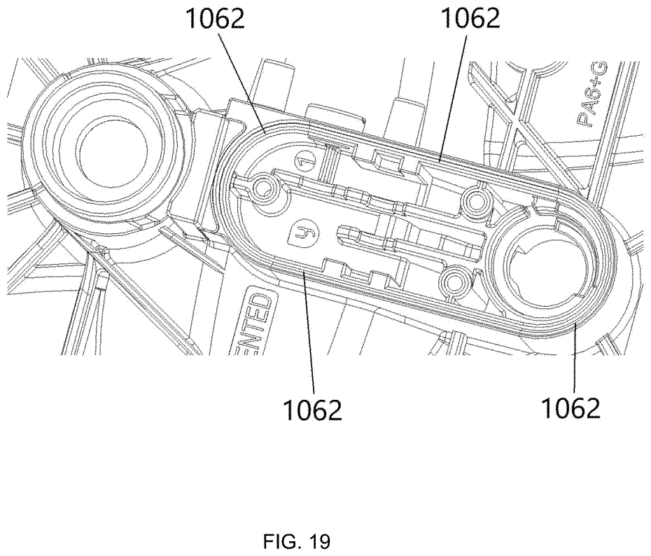

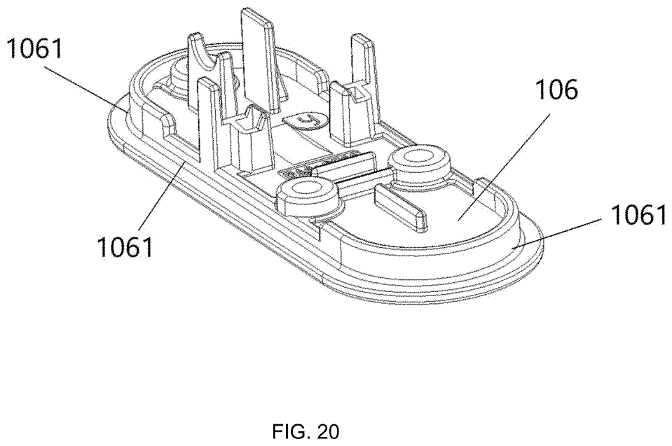

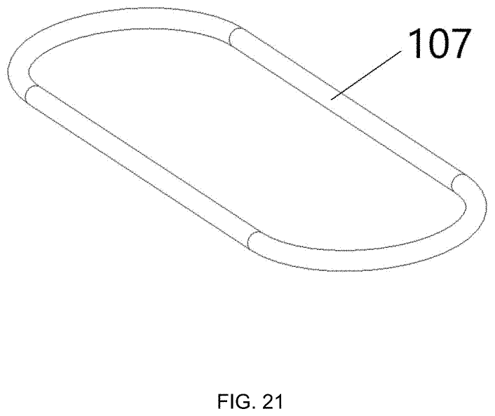

Referring to FIG. 19 to FIG. 21, the shell 1 of this embodiment includes a shell body and a rear cover 106. The shell body opens backwardly, and the rear cover 106 is in snap-fit connection with the shell body to realize to seal of the shell 1. The shell body is provided with a first sealing surface 1062, and the first sealing surface 1062 is elliptic-shaped and surrounds the aperture. The rear cover 106 is provided with a second sealing surface 1061 corresponding to the first sealing surface 1062. A second sealing ring 107 is arranged between the first sealing surface 1062 and the second sealing surface 1061 to realize the sealing effect and improve the sealing performance.

The panel lock provided in the embodiment of the present application further includes an ejection device. The ejection device is arranged between the handle 3 and the shell 1, and ejects the handle 3 to a middle position between the first position and the second position after the handle 3 is unlocked.

The ejection device includes a first ejection mechanism 6 which includes a third elastic member 601, a mounting base 602, and a spring cap 603. The mounting base 602 is disposed inside the handle 3 and located at a side of the handle 3 facing to the shell 1. One end of the third elastic member 601 is mounted in the mounting base 602, and the spring cap 603 is mounted to the other end of the third elastic member 601.

In this embodiment, the first ejection mechanism 6 can eject the handle 3 with the preset angle when the latch hook 401 is disengaged from the latch groove 301 of the handle 3 and the user needs to lift the handle 3 to the second position. It can be seen that this ejection device can make the handle 3 eject with the preset angle before the user holds the handle 3, so that there is enough space to insert user's fingers to hold the handle 3, which makes it easier to hold the handle 3 and enhances the operability of the panel lock, especially when the user wears thick gloves. In addition, thanks to the ejection device, it is not necessary to set the first groove deep, which improves the aesthetics of the panel lock.

In this embodiment, the panel lock has three usage statuses. When the panel lock needs to be locked, the first locking assembly 2 locks the panel lock with the door, and the second locking assembly 4 fix the handle 3 in the first groove 101 and the second groove 104 of the front side of the shell 1, thereby preventing the handle 3 from shaking due to external unstable factors, this is defined as a locked status. When the panel lock needs to open, the second locking assembly 4 unlocks the handle 3, and the first ejection mechanism 6 ejects the handle 3 with the preset angle for user's holding, this is defined as an ejection status. The handle 3 is lifted to the second position then rotated by the user to drive the first rotary shaft 201 to rotate, driving the locking tab 202 of the first locking assembly 2 to rotate together, thereby opening the panel lock and realizing unlock, this is defined as an unlocked status.

In an alternative embodiment, referring to FIG. 1, the first ejection mechanism 6 further includes a limiting screw 604, and the second groove 104 of the shell 1 is provided with a boss 102 at a position thereof corresponding to the first ejection mechanism 6.

The limiting screw 604 is installed beside a sidewall of the mounting base 602, and is parallel to the sidewall of the mounting base 602. A head of the limiting screw 604 extends beyond the sidewall of the mounting base 602 to limit a moving range of the spring cap 603 in the mounting base 602. The limiting screw 604 adjusts the ejection angle of the handle 3 to a desired value by restricting the maximum movement of the spring cap 603. For example, the ejection angle of the handle 3 may be adjusted to a value between 0 and 10 degrees.

The boss 102 cooperates with the first ejection mechanism 6 to eject the handle 3 with the preset angle. Generally, the preset angle is about 10 degrees. In this situation, the handle 3 will not pop up too much to occupy space, nor does it pop up too low to be difficult to hold.

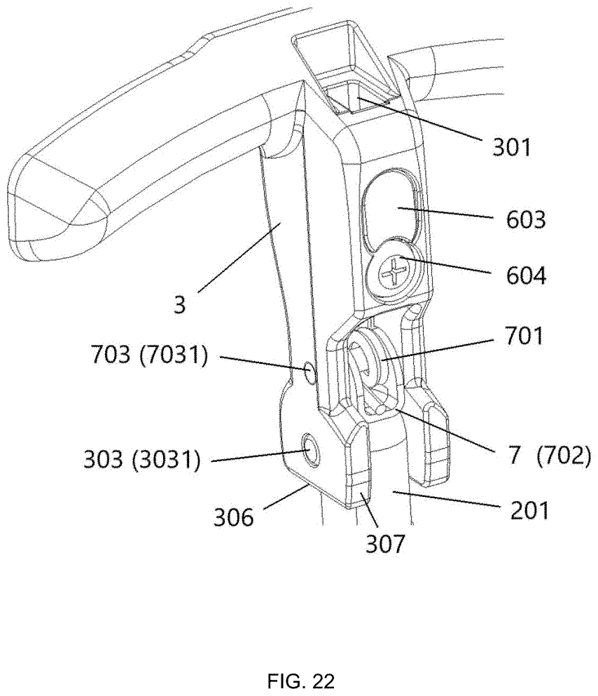

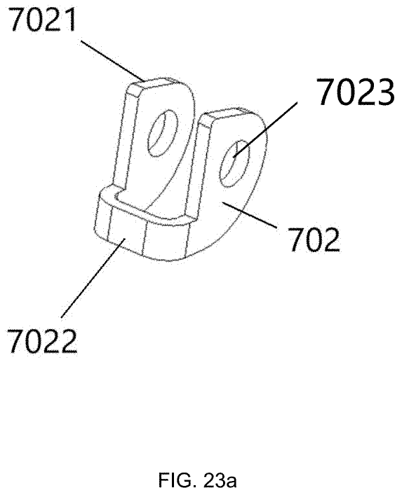

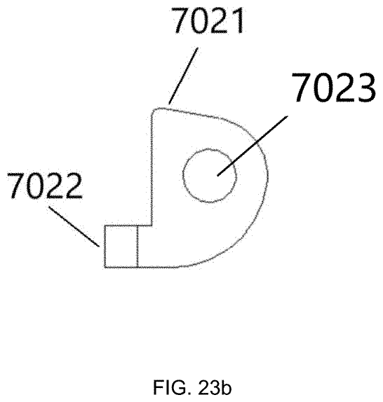

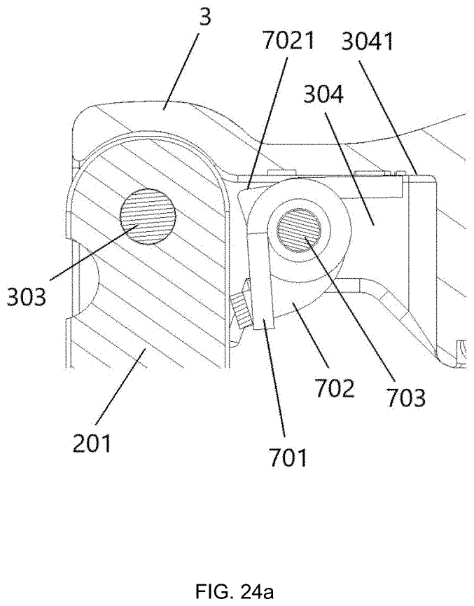

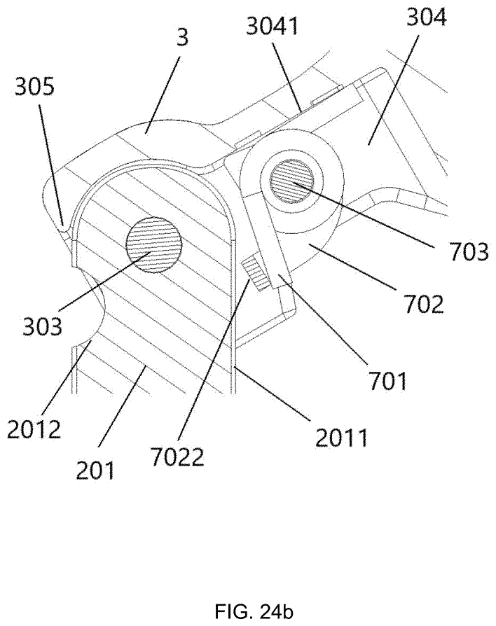

The ejection device may further include a second ejection mechanism. FIG. 22 is a schematic view of the second ejection mechanism of the panel lock provided by the embodiment of the present application, FIG. 23a is a schematic view of a spring bracket of the second ejection mechanism of FIG. 22, and FIG. 23b is a side view of the spring bracket of FIG. 23a. FIGS. 24a and 24b show working states of the second ejection mechanism of FIG. 22. Refer to FIG. 22 to FIG. 24b, the second ejection mechanism 7 is arranged at a position where the handle 3 is close to the first rotary shaft 201, and includes a spring bracket 702 and an ejecting spring 701. The spring bracket 702 is rotatably mounted to the handle 3 about a second axis. That is, the rotation axis of the spring bracket 702 with respect to the handle 3 is parallel to the rotation axis of the handle 3 with respect to the first rotation shaft 201. The ejecting spring 701 is preferably a torsion spring, one end of the ejecting spring 701 abuts against the handle 3, and the other end of the ejecting spring 701 is connected to the spring bracket 702.

The handle 3 is provided with a second axle hole 7031 at a position close to the first axle hole 3031. A bracket shaft 703 is mounted in the second axle hole 7031 and parallel to the handle shaft 303. A third axle hole 7023 is defined in the spring bracket 702. The spring bracket 702 is rotatably mounted to the handle 3 through the bracket shaft 703 which is inserted in the third axle hole 7023 and the second axle hole 7031.

The spring bracket 702 includes a first limiting surface 7021 and a second limiting surface 7022 which surround the third axle hole 7023. During the movement, the spring bracket 702 rotates about the bracket shaft 703 under the action of the ejecting spring 701, and abuts against a blocking surface 3041 of the handle 3 through the first limiting surface 7021. During approaching of the handle 3 towards the first rotary shaft 201, a first surface 2011 of the first rotary shaft 201 adjacent to the spring bracket 702 abuts against the second limiting surface 7022, and drives the spring bracket 702 to rotate, so that the first limiting surface 7021 moves away from the blocking surface 3041.

The working principle of the second ejection mechanism 7 is: after the handle 3 at the first position is released, the first surface 2011 interacts with the second limiting surface 7022, and ejects a certain angle under the action of the ejecting spring 701 until the first limiting surface 7021 contacts the blocking surface 3041.

The second ejection mechanism 7 may be used in conjunction with the first ejection mechanism 6 or may be used separately. In addition, by adjusting an angle between the first limiting surface 7021 and the second limiting surface 7022, the ejection angle of the handle 3 under the action of the second ejection mechanism 7 can be adjusted, for example, to a value between 0 and 10 degrees.

In an alternative embodiment, referring to FIG. 1, the panel lock further includes an adjusting spring 205 and a fixing ring 2032 arranged on the first rotary shaft 201. The first rotary shaft 201 is slidably mounted in the shell 1 along the first axis. The adjusting spring 205 is sleeved on the first rotary shaft 201 and is sandwiched between the shell 1 and the fixing ring 2032, and drives the first rotary shaft 201 to slide toward the rear side of the shell 1 through the fixing ring 2032.

Referring to FIG. 22, an end of the handle 3 connected to the first rotary shaft 201 includes the first axle hole 3031 and third and fourth limiting surfaces 306, 307 surrounding the first axle hole 3031. A distance between the third limiting surface 306 and the first axle hole 3031 is less than a distance between the fourth limiting surface 307 and the first axle hole 3031. The fourth limiting surface 307 abuts against the shell 1 when the handle 3 at the first position, and the third limiting surface 306 against the shell 1 when the handle 3 at the second position.

In an alternative embodiment, a wear pad may be inserted between the shell 1 and the handle 3 to reduce the friction therebetween.

Since the first rotary shaft 201 and the handle 3 are rotatably connected through the handle shaft 303, when the adjusting spring 205 pushes the fixing ring 2032 downwardly, the force is transmitted to the handle 3 through the first rotary shaft 201, and the handle 3 will press the shell 1 at the position of the handle shaft 303. When the handle 3 moves from the first position to the second position, the contacting surface between the handle 3 and the shell 1 is switched from the fourth limiting surface 307 to the third limiting surface 306. The distance between the third limiting surface 306 and the first axle hole 3031 is less than the distance between the fourth limiting surface 307 and the first axle hole 3031, and a difference may be 4 mm, thus the first rotary shaft 201 and the locking tab 202 move a short distance, such as 4 mm, towards the rear side of the shell 1 under the driving of the adjusting spring 205, which makes the locking tab 202 move away from the surface of the locking position, reduce the friction force during rotation of the locking tab 202, finally the handle is easier to twist or swing and the panel lock is easier to unlock.

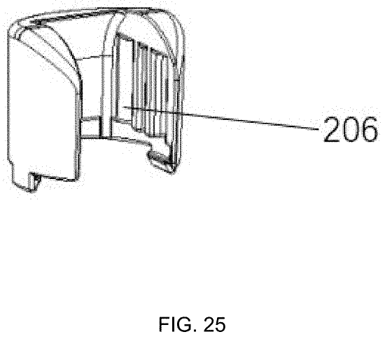

In an alternative embodiment, referring to FIG. 1 and FIG. 25, the panel lock further includes a sleeve 206, which is mounted on a hinge portion of the first rotary shaft 201 and the handle 3. The sleeve 206 is generally a plastic cover for decorative purposes. By surrounding the rotating position of the first rotary shaft 201 and the handle 3, the sleeve 206 can prevent dust and debris from entering the panel lock. In addition, the sliding range of the first rotary shaft 201 and the locking tab 202 under the driving of the adjusting spring 205 can be adjusted.

In an alternative embodiment, referring to FIG. 24a and FIG. 24b, the end of the handle 3 connected to the first rotary shaft 201 is provided with a fifth limiting surface 305 parallel to the first axle hole 3031. The first rotary shaft 201 includes a third surface opposite to the first surface 2011. The third surface defines a rotation limiting groove 2012. After the handle 3 is rotated to the second position, the fifth limiting surface 305 enters the rotation limiting groove 2012, and the rotation limiting groove 2012 cooperates with the fifth limiting surface 305 to prevent the handle 3 from further rotating.

In an alternative embodiment, an outer surface of the handle 3 is below the highest point of the periphery of the first groove 101. Such design makes the handle 3 be lower than the outer surface of the shell 1 when the handle 3 in the locked status, and avoids to occupy too much space and some unnecessary rubbing.

The above merely provides the preferred embodiments of the present disclosure, which is illustrative, rather than restrictive, to the present disclosure. However, it should be understood by those skilled in the art that, many variations, modifications even substitutions that do not depart from the spirit and scope defined by the present disclosure, shall fall into the extent of protection of the present disclosure.

What is claimed is:

1. A panel lock, comprising:
a shell;
a rotary shaft rotatably mounted in the shell;
a locking tab connected to and rotating along with the rotary shaft to realize unlocking and locking;
a handle rotatably mounted to the rotating shaft, the handle having a first position being folded relative to the shell and a second position being lifted at a preset angle relative to the shell during rotation about a first axis perpendicular to the rotating shaft, the handle comprising a latching groove and a guiding portion arranged at a side of the latching groove,
a latch hook rotatably mounted in the shell; and
a first elastic spring arranged between the latch hook and the shell;
wherein when the handle is at the first position, the latch hook engages into the latching groove under the driving of the first elastic member to prevent the handle from leaving the first position; and during rotation of the handle from the second position to the first position, the guiding portion stretches the latch hook and guides the latch hook into the latching groove.

2. The panel lock of claim 1, wherein the latch hook has a third position, a fourth position and a fifth position during rotation, and wherein,
the latch hook at the third position is pressed into the latching groove under the driving of the first elastic member and makes the handle be fixed at the first position;
the latch hook at the fourth position disengages from the latching groove and makes the handle be capable of disengaging from the first position;
the latch hook rotates from the fourth position to the fifth position under the driving of the first elastic member when the handle is lifted, the fifth position is the same as the third position except the latch hook disengages from the latching groove and is below the latch groove; and
during rotation of the handle from the second position to the first position, the guiding portion stretches the latch hook and guides the latch hook moving from the fifth position back to the third position.

3. The panel lock of claim 2, further comprising an unlocking member and a drive mechanism connected to the unlocking member, the unlocking member being movably mounted in the shell and driving the latch hook to move from the third position to the fourth position through the drive mechanism.

4. The panel lock of claim 3, wherein the unlocking member comprises a locking core which rotates under the driving of a key, and the drive mechanism comprises a driven member rotating along with the locking core, a first slider slidably mounted in the shell and a first conversion unit arranged between the driven member and the first slider, the driven member drives the first slider to slide through the first conversion unit during rotation of the driven member, and the first slider drives the latch hook to move from the third position to the fourth position during sliding of the first slider.

5. The panel lock of claim 4, wherein the latch hook comprises a hook portion and a protrusion arranged around a rotating portion thereof, the hook portion matches with the latching groove, and the first slider pushes the protrusion during the sliding motion of the first slider.

6. The panel lock of claim 4, wherein the drive mechanism further comprises a second elastic member, and the first slider is located at a position away from the latch hook under the action of the second elastic member.

7. The panel lock of claim 4, wherein the first conversion unit comprises a rotation protrusion and a slot, the rotation protrusion is formed on one of the driven member and the first slider, the slot is defined in the other one of the driven member and the first slider, and the rotation protrusion cooperates with the slot to implement the transformation from rotation to linear motion.

8. The panel lock of claim 4, wherein the first conversion unit comprises a gear and rack, the gear is mounted on one of the driven member and the first slider, the rack is mounted on the other one of the driven member and the first slider, and the gear meshes with the rack to implement the transformation from rotation to linear motion.

9. The panel lock of claim 3, wherein the unlocking member comprises an unlocking button being slidably mounted in the shell, and the drive mechanism comprises a second slider and a second conversion unit, the second slider is slidably mounted in the shell, the second conversion unit is arranged between the unlocking button and the second slider, the unlocking button drives the second slider to slide through the second conversion unit, and the second slider drives the latch hook to move from the third position to the fourth position during the sliding motion of the second slider.

10. The panel lock of claim 9, wherein the second conversion unit comprises an inclined face provided on the second slider and a driving end provided on the unlocking button, and the inclined face and the driving end are in sliding contact with each other to realize conversion of sliding directions of the unlocking button and the second slider.

11. The panel lock of claim 10, wherein the unlocking member further comprises a locking core which rotates under the driving of a key, and a locking member prevents the unlocking button from sliding when the locking core rotates to a target position.

12. The panel lock of claim 1, wherein the latch hook is provided with a protrusion at a position surrounding a rotating portion thereof, an unlocking shaft is mounted in the shell, the unlocking shaft comprises a cam portion for driving the latch hook to unlock the handle through the protrusion during rotation of the unlocking shaft, and the unlocking shaft comprises an exposed external interface.

13. The panel lock of claim 1, wherein at least one of the handle and the shell is provided with an ejection device, and the ejection device drives the handle which is disengaged from the latch hook to move to a middle position between the first position and the second position.

14. The panel lock of claim 13, wherein the ejection device comprises a first ejection mechanism, and the first ejection mechanism comprises a mounting base arranged on the handle, a third elastic member, a spring cap and a boss formed on the shell, the spring cap is slidably mounted to the mounting base, the third elastic member is arranged between the spring cap and the mounting base and drives the spring cap to move to an outside of the mounting base, and the boss abuts against the spring cap when the handle moves to the first position.

15. The panel lock of claim 14, wherein the ejection device further comprises a second ejection mechanism, and the second ejection mechanism comprises a spring bracket rotatably mounted to the handle and an ejecting spring mounted to the spring bracket, one end of the ejecting spring abuts against the handle, the other end of the ejecting spring abuts against the spring bracket, and the rotary shaft abuts against the spring bracket and compress the spring when the handle moves to the first position.

16. The panel lock of claim 1, wherein when the handle at the second position rotates about the rotary shaft, the rotary shaft and the latching tab are driven to rotate from a locking position to an unlocking position to realize unlocking, or are driven to rotate from the unlocking position to the locking position to realize locking.
